(19) United States
(12) Patent Application Publication
(10) Pub. No.: US 2008/0225834 A1
(43) Pub. Date: Sep. 18, 2008

(54) Method for Supporting the Service Features "Call Hold", "Conference Calling" and "Three-Party Service" in Fmc Networks

(75) Inventor: Klaus Hoffmann, Munchen (DE)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO., München (DE)

(21) Appl. No.: 11/997,753

(22) PCT Filed: Jul. 13, 2006
(86) PCT No.: PCT/EP06/64200

§ 371 Date: Feb. 8, 2008

(30) Foreign Application Priority Data
Aug. 3, 2005 (DE) 10 2005 036 522.1

(51) Int. Cl. H04L 12/66

(52) U.S. Cl. 370/352

(57) ABSTRACT

The prior art cannot implement the feature call hold in a FMC network (fixed mobile conversion, i.e. mixed mobile fixed networks). This is due to the fact that the feature call hold as well as the features conference calling and three-party service have different definitions in the two standards ITU-T Q1912.5 and 3GPP TS 24.228 with which incompatible procedures are defined. Compatibility problems arise since all involved units in the FMC networks with different units such as clients and network transition units necessitate an inter-working of all interlinked units. This problem is resolved by providing a mapping functionality that converts the protocol elements of both standards into one another.

More recent communication architectures provide for call-processing networks to be separated into connection-service-related units and transport of the useful information (bearer control). This results in decomposition/separation of connection setup and medium or bearer setup. In this case, the useful information can be transmitted (connection of the useful channel) using different high bit rate transport technologies such as ATM, IP or Frame Relay.

Such separation allows the telecommunication services currently carried in narrowband networks to be implemented in broadband networks too. This involves the subscribers being connected either directly (e.g. using a DSS1 protocol) or via exchanges in the form of media gateway controllers (MGCs) (e.g. using the ISUP protocol). The useful information itself is converted to the respectively used transport technology by means of media gateways (MGs).

The media gateways are controlled by respective associated media gateway controllers (MGCs). To control the media gateways, the media gateway controllers use standardized protocols, such as the MGCP protocol or the H.248 protocol. For communication with one another, the media gateway controllers use a BICC (Bearer Independent Call Control) protocol, standardized by the ITU, which is formed from a plurality of standardized protocols and therefore comprises a protocol family.

A suitable protocol for the BICC protocol has been created on the IETF standardization committee with the SIP protocol (RFC3261) and the supplement SIP-T (RFC3204). The latter allows ISUP messages to be transmitted—in contrast to the SIP protocol. In general, the ISUP messages are transmitted through tunnels, i.e. by handing them through transparently.

The connection setup between 2 or more SIP subscribers is effected using SIP protocol elements. In this context, SDP (Session Description Protocol) data are interchanged, inter alia. SDP data are (bearer) endpoint-related data which contain information about codecs, IP-port, IP-address etc. When a connection needs to be set up between an SIP subscriber and an H.323 or TDM/ISDN subscriber, these SIP protocol elements need to be converted to H.323, TDM or ISDN protocol elements as appropriate in the media gateway controllers involved. By way of example, for a TDM subscriber called from the SIP world, this means that the ISUP messages used in the TDM world, such as the ISUP message IAM (Initial Address Message), need to be produced and supplied to said subscriber.

Initial fundamental considerations within the ITU-T have resulted in draft recommendation Q.1912.5 “interworking SIP and BICC/ISUP”. In this context, initial considerations have also already been given to the supplementary services known from the ISDN world, which also include the service feature “Call Hold”. “Call Hold” means that a call is parked or put on hold in order to direct a query to another subscriber or to forward the call to another subscriber, or to initiate a conference “Conference Calling” (CONF) and “Three-Party Service” (3PTY) and disconnect it again, for example.

In principle, the ITU-T Q.1912.5 recommendation specifies the circumstances which arise between SIP and PSTN subscribers. In this case, no distinction is drawn between line-connected and mobile subscribers. Specifically, ITU-T Recommendation Q.1912.5, section B.10, table B.10-1 now specifies that the SIP protocol element RE-INVITE for the service feature “Call Hold” is not interchanged between the two subscribers until both are in the call state (Talking State), that is to say that the called subscriber has picked up.

The standardization committee 3GPP for mobile subscribers has now also adopted an SIP protocol element UPDATE from the IETF, which is originally interchanged between two subscribers who have not yet entered a call state, that is to say where the called subscriber has not yet picked up. These conditions have been extended such that the SIP protocol element UPDATE can now be interchanged even during a call state. Specifically 3GPP Specification 3GPP TS 24.228, V5.11.0, section 10.1.3, page 403, discusses the service feature “Call Hold” from the point of view of 3GPP. This document stipulates that a mobile terminal needs to use an SIP protocol element UPDATE in an active call in order to implement “Call Hold”. For FMC networks (fixed mobile conversion, i.e. hybrid mobile/landline networks), however, mobile subscribers are not used either, or MGCs and MGCFs, which use the SIP protocol element RE-INVITE for this purposes as standard (e.g. in line with Q.1912.5 from ITU-T).

One problem is now that in FMC networks with different units, such as clients and network gateway units (MGCF, MGC etc.), all interlinked units will end up interworking. Since the service feature “Call Hold” is based on the different definitions of the 3GPP and ITU-T Recommendation Q1912.5, incompatible procedures are therefore defined for “Call Hold”. Accordingly, these units cannot readily handle the service feature “Call Hold” together, since different signals are used. The same applies to the service features “Conference Calling” (CONF) and “Three-Party Service” (3PTY).

In addition, an IMS unit which is responsible for event charging (e.g. CSCF) would currently, in the case of FMC interworking between two landline network subscribers, not be able to tell at all that, by way of example, the feature Hold is being implemented by a landline network subscriber (using RE-INVITE). This means that the network operator would first of all lose a charging opportunity in the IMS, or the service would not be provided at all on account of the incompatibility.

The invention is based on the object of demonstrating a way in which the service features “Call Hold”, “Conference Calling” and “Three-Party Service” can be implemented in FMC networks.

The invention is achieved on the basis of the features specified in the precharacterizing part of patent claim 1 by the features claimed in the characterizing parts.

The advantage of the invention can be seen in that a mapping functionality is provided which easily converts the SIP protocol elements UPDATE and RE-INVITE to one another. Hence, the proposed solution actually makes it possible to implement service features such as “Call Hold”, “Conference Calling” and “Three-Party Service” in FMC networks.

The invention is explained in more detail below using an exemplary embodiment which is illustrated in the figures, in which:

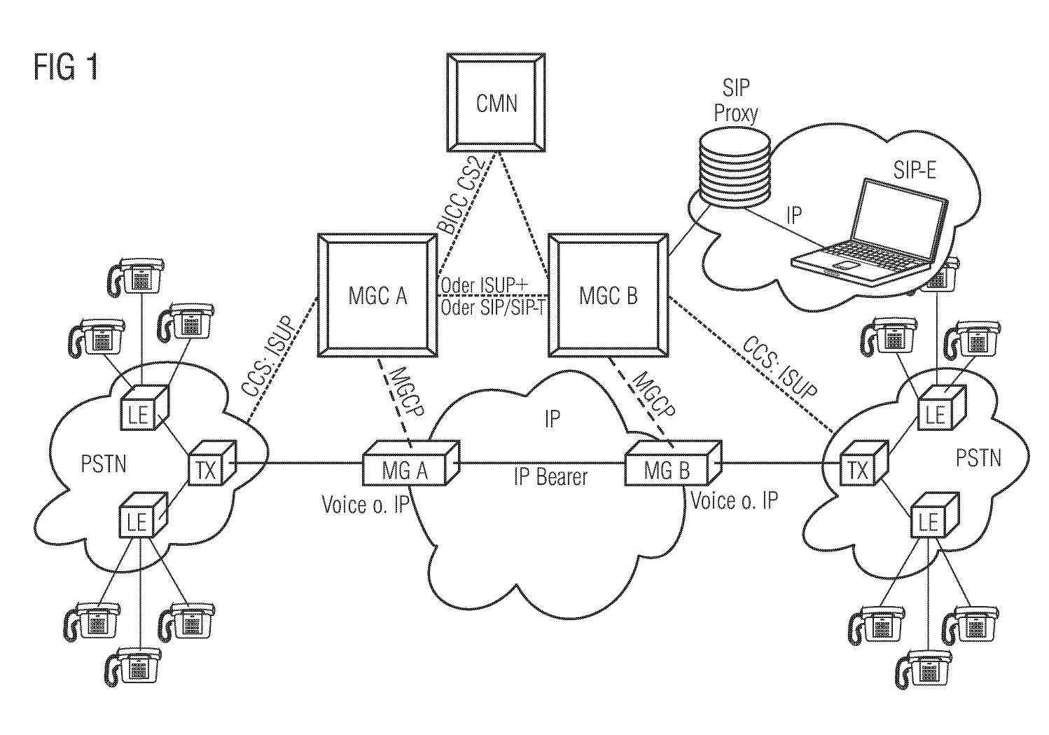

FIG. 1 shows the fundamental circumstances between 2 PSTN subscribers, who have an internet network arranged between them,

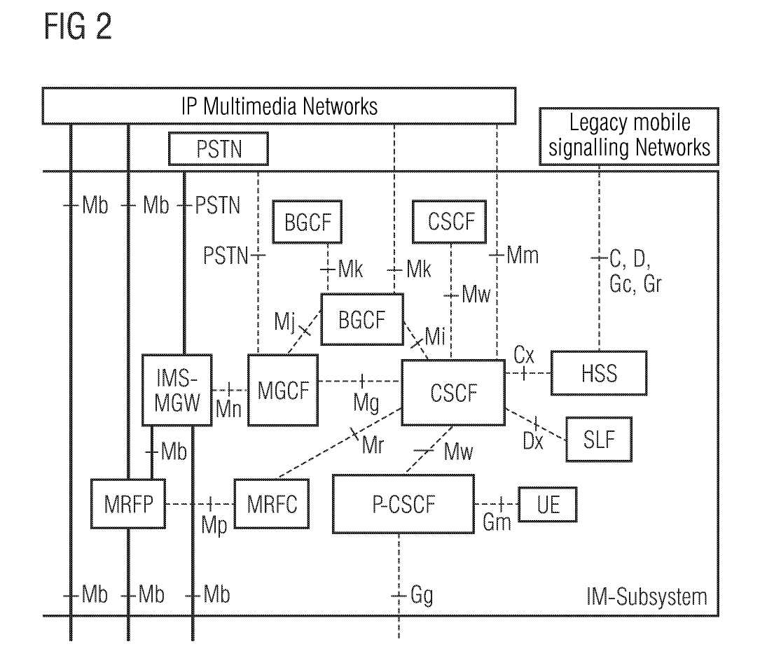

FIG. 2 shows the IM subsystem based on TS24.229 standard,

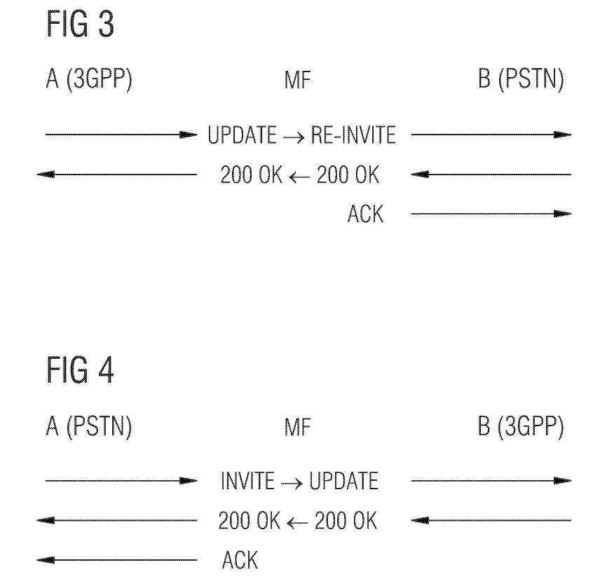

FIG. 3 shows the circumstances in FMC networks using the example of the service feature “Call Hold” from subscriber A to B,

FIG. 4 shows the circumstances in FMC networks using the example of the service feature “Call Hold” from subscriber B to A.

FIG. 1 discloses 2 PSTN networks by way of example which respectively contain a plurality of PSTN subscribers in a known manner. These are routed to local exchanges LE which for their part are connected to transit exchanges TX.

The transit exchanges TX now separate signaling information and useful information. The signaling information is supplied by the transit exchange TX to a respective associated media gateway controller MGC (MGC A or MGC B) directly using an ISUP protocol. The useful information is transmitted to a media gateway MG (arranged on the input side) (MG A or MG B), which acts as an interface between the TDM network and an ATM or IP transmission network, and is transmitted in packet-orientated fashion via the relevant transmission network. The media gateway MG A is controlled by the media gateway controller MGC A in the same way as the media gateway MG B is controlled by the media gateway controller MGC B. When the useful information is transmitted from the media gateway MG A to the media gateway MG B, the useful information is converted to a TDM data stream and supplied to the PSTN subscriber in question, again under the control of the media gateway controller MGC B associated with the media gateway MG B. The data transmitted between the media gateway controller MGC and the respective associated media gateway are supported by a standardized protocol. This may be the MGCP or the H.248 protocol, for example. Between the two media gateway controllers MGC A, MGC B, the SIP protocol is preferably used in line with the present exemplary embodiment. It is also possible for other devices such as SIP proxies or SIP units SIP E to be connected in the signaling path.

FIG. 2 shows the definition and tasks of the IMS system based on the 3GPP TS 23.002 V6.5.0 (2004-06) standard. In this context, a BCGF (Breakout Gateway Control Function) functionality is described. In addition, devices CSCF, P-CSCF and other devices are shown, whose interaction is likewise explained in the above standard. By way of example, the BGCF function (Breakout Gateway Control Function) selects the network (domain, e.g. PSTN) to which the call coming from an SIP terminal UE needs to be routed. If the BGCF function stipulates that the destination is in its own network, i.e. in the network which controls the BGCF function, the BGCF function selects an MGCF functionality which is responsible for the interworking with the PSTN network. If the destination is in another network, the BGCF functionality forwards the signaling to the other network.

FIG. 3 shows the inventive method using the example of the service feature “Call Hold”. The 3 service features “Call Hold”, “Conference Calling” and “Three-Party Service” have the underlying problem that the SDP data of the terminals need to be modified. Accordingly, a mapping functionality MF is provided which converts the SIP protocol element/message UPDATE to the SIP protocol element RE-INVITE. In this context, it is assumed that subscriber A is a 3GPP subscriber and subscriber B is a PSTN subscriber. It is also assumed that subscriber A is the calling subscriber. In line with the definition of the service “Call Hold”, it makes no difference to the service which is the calling subscriber and which is the called subscriber. Subscriber A now sends the SIP protocol element UPDATE to the called subscriber B on the basis of the ITU-T standard. The mapping functionality MF now receives the SIP protocol element UPDATE and converts it to the SIP protocol element RE-INVITE. In this case, the SDP data of the terminals based on RFC3264 “An Offer/Answer Model Session Description Protocol” and hence information about the service feature “Call hold” are also mapped without loss of information. The called subscriber B now receives the SIP protocol element RE-INVITE and acknowledges it using an SIP protocol signal 200 OK for the SIP protocol element RE-INVITE. The mapping functionality MF receives this acknowledgement and converts it to the SIP acknowledgement signal 200 OK for SIP protocol element UPDATE. Finally, the mapping functionality MP acknowledges the process to the subscriber B using a signal ACK.

FIG. 4 shows the opposite process, i.e. subscriber A is a PSTN subscriber and subscriber B is a 3GPP subscriber. In this case, the calling subscriber will be the PSTN subscriber A. The protocol information is converted by the mapping functionality MF in similar fashion, as described in FIG. 3.

The mapping functionality MF may be arranged in the device CSCF, BGCF or an application server, or else in the device MGCF.

1-5. (canceled)

6. A method for providing session description protocol (SDP) data in fixed mobile conversion (FMC) networks formed from a mobile network component and a landline network component, which comprises the steps of:
routing, via the mobile network component, the SDP data;
converting the SDP data being initially in a first SIP protocol element based on a first standard by a mapping function to a second SIP protocol element based on a second standard without loss of information from the SDP data; and
routing, via the landline network component, the SDP data in the second SIP protocol element.

7. The method according to claim 6, which further comprises using a SIP protocol element UPDATE as the first SIP protocol element.

8. The method according to claim 6, which further comprises using a SIP protocol element RE-INVITE as the second SIP protocol element.

9. The method according to claim 6, which further comprises using ITU Standard Q.1912.5 as the first standard.

10. The method according to claim 6, which further comprises using 3GPP Standard TS 24.228 as the second standard.
